(19) United States
(12) Patent Application Publication
(10) Pub. No.: US 2015/0244600 A1
(43) Pub. Date: Aug. 27, 2015

(54) STRUCTURED LOGGING SCHEMA OF USAGE DATA

(71) Applicant: Microsoft Corporation, Redmond, WA (US)

(72) Inventors: Aravind Ranganathan, Redmond, WA (US); Sanghmitra Gite, Redmond, WA (US)

(73) Assignee: Microsoft Corporation, Redmond, WA (US)

(21) Appl. No.: 14/190,676

(22) Filed: Feb. 26, 2014

(51) Int. Cl. H04L 12/26

(52) U.S. Cl. CPC H04L 43/0876

(57) ABSTRACT

Technologies are generally described to provide a logging schema to track requests processed by a service. A request may be received at a collaborative service, and the request may be processed by one or more subsystems of the service to fulfill the request. The logging schema may be configured to track user requests as each request is received and processed at each individual subsystem of the collaborative service. A logging entry may be created at a data store of the service, where the logging entry includes a subsystem name, an operation performed by the subsystem to fulfill the request, error information, and start and end times of the operation. The logging schema may enable continuous monitoring of a performance of the system, such as which operations take the most time, which operations have the most success and the least success, and which features are most popular based on usage data.

### BACKGROUND

In a collaborative environment, users may interact with a collaborative service over a network. The collaborative service may be a service providing a multitude of applications and capabilities to many users over the network concurrently. The collaborative service may monitor traffic patterns and data requests from the multiple users in order to continuously monitor performance and reliability of the service. Tracking large amounts of data requests received at the collaborative service and processed by multiple subsystems of the service may create a complex set of data, and it may be difficult to aggregate and sort through the data to extract valuable service related metrics for consistently evaluating system performance and reliability.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to a logging schema to track requests between subsystems of a service. The logging schema may be configured to track user requests as each request is received and processed at individual subsystems of the collaborative service. A logging entry may be created at a data store of the service, where the logging entry may include a subsystem processing the request, an operation performed by the subsystem to fulfill the request, start and end times of the operation, locale information for the request, and errors detected in fulfilling the requests. The logging schema may enable continuous monitoring of a performance of the system such as which operations take the most time, and which operations have the most and the least success.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 illustrates an example cloud-based environment where users interact with a collaborative service over a network;

FIG. 2 illustrates a conceptual diagram of tracking and logging usage data between subsystems of a service;

FIG. 3 illustrates an example architecture of a service including a plurality of subsystems where a logging schema for tracking usage data may be implemented;

FIG. 4 is a networked environment, where a system according to embodiments may be implemented;

FIG. 5 is a block diagram of an example computing operating environment, where embodiments may be implemented; and

FIG. 6 illustrates a logic flow diagram for a process of employing a logging schema to track usage data between subsystems of a service, according to embodiments.

### DETAILED DESCRIPTION

As briefly described above, a logging schema is provided to track usage data at a service such as a collaborative service. Requests may be received at a collaborative service, and the request may be processed by one or more subsystems of the service to fulfill the request. A logging schema may be configured to track user requests as each request is received and processed at each individual subsystem of the collaborative service. A logging entry may be created at a data store of the service, where the logging entry may include information about each individual request. Each logging entry may include a name of a subsystem processing the request, an operation performed by the subsystem to fulfill the request, start and end times of the operation, user locale information, and errors detected in processing the request. The logging schema may enable continuous monitoring of the service and calculation of various service metrics such as system performance, reliability, user traffic, and error rates.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

Throughout this specification, the term “platform” may be a combination of software and hardware components for a logging schema to track usage data between subsystems of a service. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below.

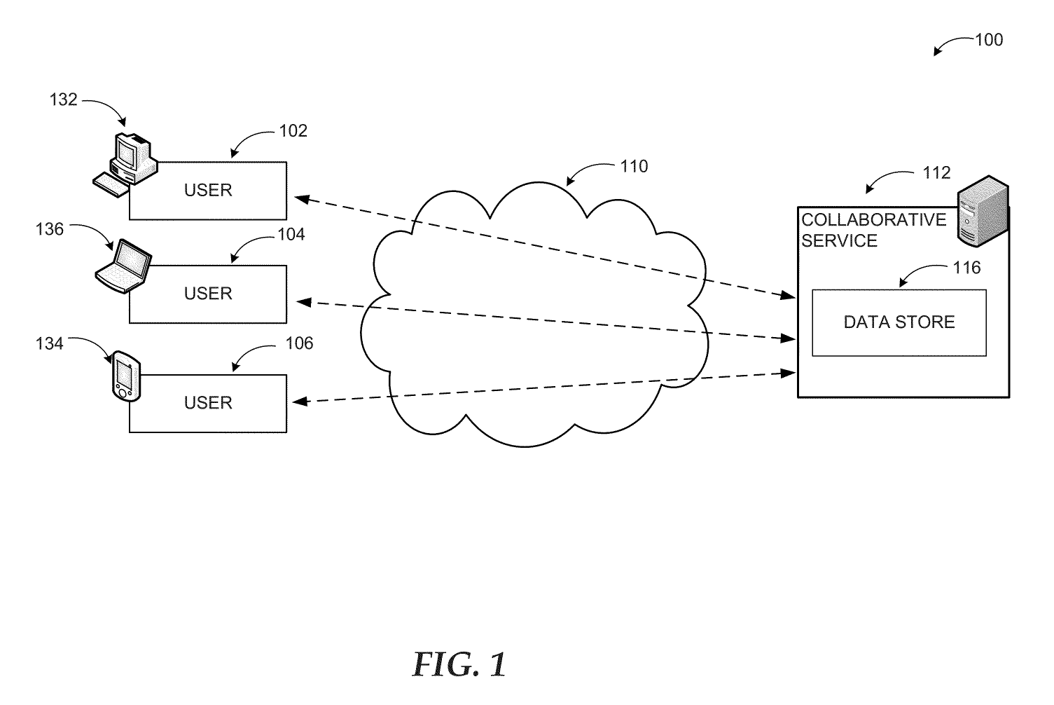

FIG. 1 illustrates an example cloud-based environment where users interact with a collaborative service, according to some example embodiments.

As demonstrated in diagram 100, users (102, 104, and 106) may access a service or application such as a collaborative service 112, over a cloud-based network 110. The collaborative service 112 may be hosted at a remote server, and may be accessed through a user's client device over the cloud-based network 110. A local version of the collaborative service 112 may also be locally hosted at the user's client device, and data associated with the local collaborative service 112 may be retrieved over the cloud-based network 110. Some example client devices may include a laptop computer 136, a desktop computer 132, a smart phone 134, a car phone, a mobile phone, a tablet, and/or a home automation device.

An example collaborative service 112 may be a service enabling multiple users to access multiple applications associated with the service over a network, such as the cloud-based network 110. Applications associated with the service may provide a multitude of tools and capabilities such as document and file management, collaboration, social networks, extranets, websites, enterprise management, document sharing, email, text messaging, voice over internet protocol (VOIP), conferencing, instant messaging, phone calls, contacts, management, calendar management, and other similar capabilities, to name a few. The collaborative service 112 may also provide system integration, process integration, and workflow automation capabilities. Different types of data associated with the collaborative service 112 such as software data, application data, communication data (e.g. email messages, text messages, instant messages, voicemail messages), and other similar data may be received from the collaborative service 112 and interacted with at the user's client device.

Data associated with the collaborative service 112 may be hosted at a data store 116 associated with the collaborative service 112. The data store 116 may retrieve and store data as requested by applications associated with the collaborative service 112, including applications locally executed on individual client devices across a network, such as the cloud based network 110. In an example embodiment, when a user interacts with the collaborative service 112 over the network from the user's client device, a request may be sent to the collaborative service 112 to retrieve data in order to respond to and fulfill the request. Example requests may include starting an application, opening a document, initiating a conversation, interacting with a document or application, retrieving data associated with an application, and other similar requests. The collaborative service 112 may continuously receive a multitude of requests from multiple users accessing the collaborative service 112 over the network. Tracking the multitude of data requests may enable detailed monitoring of a performance of the collaborative service 112, and may enable calculation of various service metrics and key performance indicators of the collaborative service 112 such as system performance, reliability, user request traffic, and error rates. A system according to embodiments may provide a logging schema to track usage data as requests are received and processed by subsystems of the collaborative service 112.

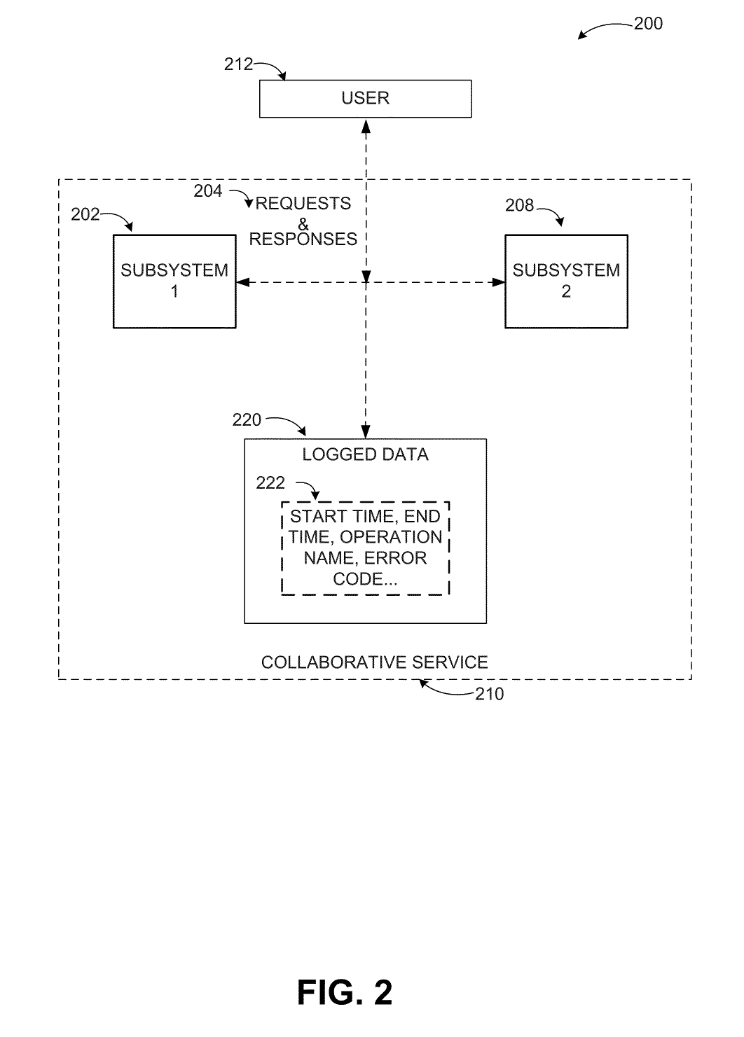

FIG. 2 illustrates a conceptual diagram of tracking and logging usage data between subsystems of a service, according to some embodiments.

As illustrated in diagram 200, a user 212 may initiate a request 204 at a user's client device, and the request 204 may be received by the collaborative service 210. The collaborative service 210 may include a plurality of layers or subsystems (e.g. subsystem 202 and subsystem 208) configured to process the request 204. The collaborative service 210 may also perform a set of actions to fulfill a request, where the set of actions may not be confined to a particular subsystem. After receipt of the request at a front end of the collaborative service 210, the request 204 may be processed by the one or more subsystems 202, 208 of the collaborative service 210 in order to fulfill the request 204. The request 204 may go through multiple subsystems of the collaborative service 210 in order to fulfill the request. The collaborative service 210 may receive a multitude of requests from multiple users accessing the collaborative service 210 over a network, and may need to keep track of the multiple requests in order to maintain a record of service performance and reliability, traffic volume, and to track errors. Additionally, maintaining a record of user requests may enable the collaborative service 210 to monitor other key performance indicators to continuously improve the collaborative service 210. The record of user requests may also enable observation of popular features of the service based on user traffic subsystems seeing least and most usage, and observation about a nature of user interaction with the service, such as a pattern of operations performed by a user under various scenarios.

In a system according to embodiments, usage data for the user requests associated with the collaborative service 210 may be tracked and stored according to a logging schema in order to keep a detailed record of requests received and processed by the collaborative service 210. The logging schema may be configured to track usage data as each request is received and processed by the collaborative service 210 and at each individual subsystem of the collaborative service 210 in order to track a processing path of the request. The logging schema may track usage data at a subsystem level, and may also track and log usage data for sub-operations within each sub-system to process the request as well. As the usage data is tracked at each subsystem (e.g. subsystems 202 and 208) of the collaborative service 210, the usage data may be logged 220 at a data store at a back end of the collaborative service 210. The data store at the back end may include a data store interface configured to receive usage data from multiple different services as part of a distributed system. The data store associated with the collaborative service 210 may also be an external data store hosted separately from the collaborative service as part of a 210. An external data store may receive data from multiple different services as part of a distributed system.

Users and administrators of the collaborative service 210 may be able to access the logged 220 data at the data store in order to analyze performance of the collaborative service 210. Example tracked and logged data 222 according to the logging schema may include an identity of a requesting user, a locale of the requesting user, a start time of a request at each subsystem, an end time of a request at each subsystem, a processing time of a request at each subsystem, a given operation name of a request at each subsystem, an error detection name, description, and code, and other additional notes relevant to the operation. Specific user information may also be anonymized to protect user privacy. Additional data types may be defined and tracked at each subsystem of the collaborative service to enable the logging schema to be scalable and customizable according to needs of the collaborative service 210. Administrators may also be able to define what subsystems to collect data from and a frequency of data collection according to service needs.

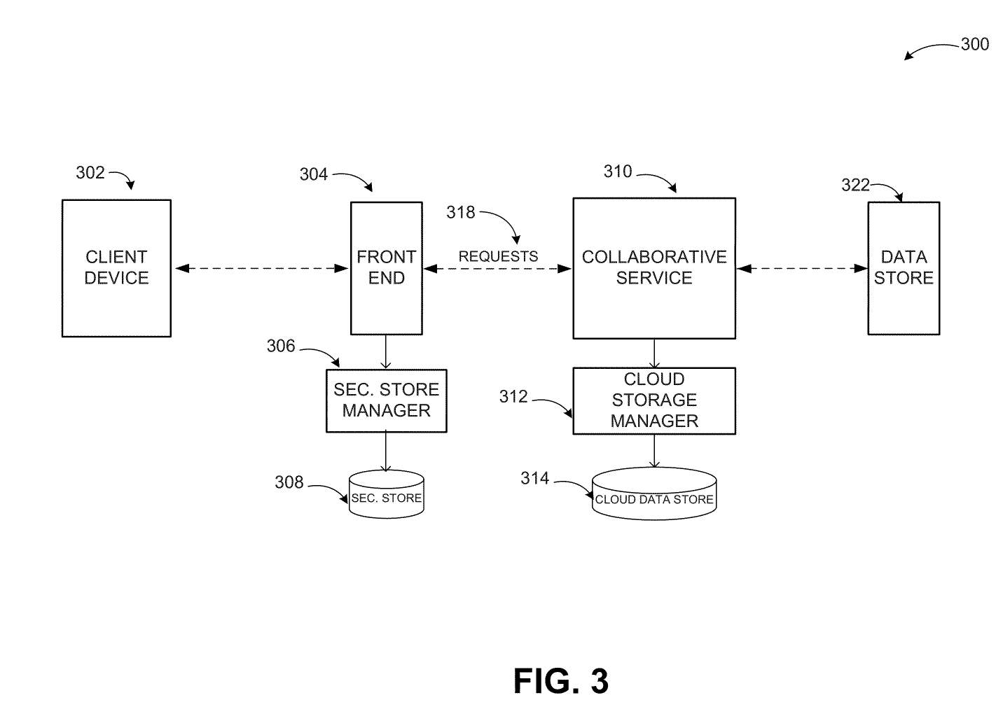

FIG. 3 illustrates an example architecture of a service including a plurality of subsystems where a logging schema for tracking usage data may be implemented, according to some embodiments.

As previously described, a logging schema may be employed to track data requests 318 between subsystems of a collaborative service 310 in order to provide detailed information about performance and reliability of the collaborative service 310. As illustrated in diagram 300, the collaborative service 310 may include multiple subsystems or layers. Example layers may include a front end 304 where a request may be initially received from a client device 302 over a network, a middle layer, which may include a multitude of subsystems (e.g. 306, 308, 312, 314) configured to fulfill particular data requests 318, and a back end data store 322 where data associated with each layer and subsystem of the collaborative service 310 may be stored. The different layers and/or subsystems may be executed on different virtual machines associated with the collaborative service 310 or may be on a same virtual machine. The logging schema may be configured to track requests 318 as the requests 318 travel sequentially or in parallel across different subsystems and virtual machines of the collaborative service before the request is processed and a response is returned to the user.

In a system according to embodiments, the logging schema may enable logging of operations that are being executed by the subsystems (e.g. 306, 308, 312, 314), and may provide detailed descriptions of the operations to be logged. Each request may be tracked as it enters and exits each subsystem of the collaborative service 310, and the logging schema may provide a subsystem and operation based entry in the back end data store 322 for each request received and processed by the collaborative service 310. Each entry at the back end data store 322 may include the subsystem and operation name, an entry and exit time from each subsystem, user locale information for the initial request, and error information associated with processing of the request at each subsystem.

In an example scenario, when a request is received, the logging schema may identify and name the subsystem where the request is received and an operation is initiated. The subsystem name may be a component of the collaborative service 310 that handles the request. Additionally the logging schema may provide an operation name to define the particular operation executed by the subsystem to process the request. A start time and end time of the operation at the subsystem may also be recorded. The end time may be used with the start time to determine a response time or a processing time of the subsystem required to provide a response to a request. A user locale for a requesting user may also be logged with each entry to enable user specific data logging. The logging entry for the request including the subsystem name, operation name, start time and end time, and user locale may be stored at the back end data store 322 of the collaborative service. The logging schema may also be configured to distinguish between real user requests and bot requests. The logging schema may de-prioritize bot requests in logging usage data to avoid experiencing decrease in performance. The logging schema may also be configured to distinguish service-bots, which may be internal service bots, from external bots, in order to keep track of internal and external bot requested operations.

The logging schema may also enable error detection and tracking as subsystems process the requests 318, and log errors at the back end data store 322. For example, an error message may be returned if there is a problem processing a request at a subsystem of the collaborative service 310. When an error processing the request is detected, the logging schema may record an error with the logging entry at the back end data store 322. The logging entry may include an error description, which may include a detailed description of the type of processing error that occurred and the subsystem name where the error occurred. A blank error description may be entered with a logging entry when no error is detected, or when the request is successfully processed. The error description may include an internal error code, which may be a local code identifier for the error that may be recognized by the collaborative service 310. The internal error code may be mapped to the error description to provide a user friendly error description that a user of the collaborative service may recognize and understand. The logging schema may log an internal error code as well as the user facing string, which may provide valuable error data. The user facing error message may be localized, such that for a same internal error, different error messages based on user localization may be generated. The logging entry for the error may also include an error type, which may include a locale agnostic string to categorize the type of the error that was detected for the request and associated operation at the subsystem.

The logging schema for storing collaborative service 310 usage history at the data store may enable continuous monitoring of a performance, health, availability and reliability of the collaborative service. While storing the usage history and continuously monitoring the performance of the collaborative service, requests may continue to be received and processed without causing delay or interruption in performing operations and fulfilling requests. For example, if an error or failure is detected, the error may be logged without interfering with processing the request or returning a response to the user. Administrators of the collaborative service 310 may be able to provide enhanced customer support to resolve issues proactively based on the passive monitoring of the logged data. Additionally, the logging schema may enable automation of identification, raising of escalations, and resolution of issues detected at the collaborative service 310. The logging schema may be scalable and customizable to enable subsystems of the collaborative service to be added and removed from the logging schema tracking without disrupting continuous service monitoring. Furthermore, the logging entries at the back end data store 322 may be auditable, such that administrators of the collaborative service may be able to identify and examine specific logging entries of interest to monitor performance issues.

The example applications, devices, and modules, depicted in FIGS. 1-3 are provided for illustration purposes only. Embodiments are not limited to the configurations and content shown in the example diagrams, and may be implemented using other engines, client applications, service providers, and modules employing the principles described herein

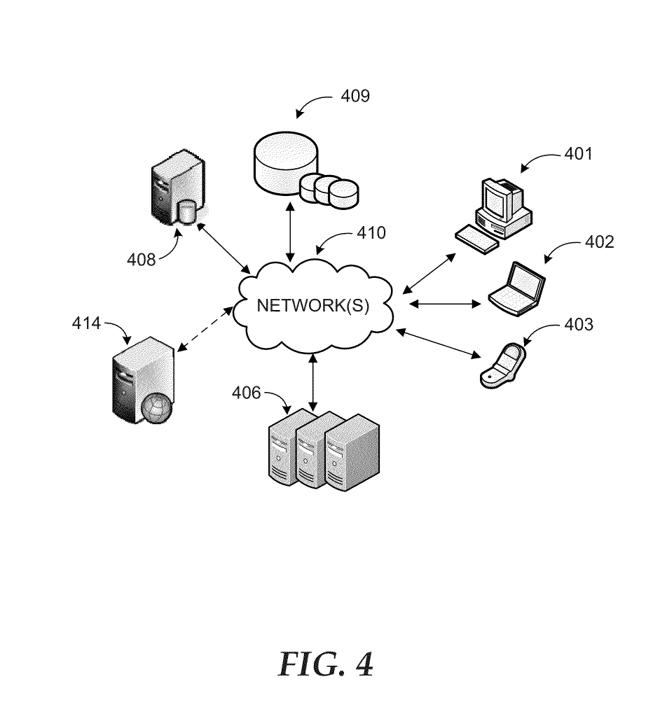

FIG. 4 is an example networked environment, where embodiments may be implemented. In addition to locally installed applications, a logging schema is provided to track usage data between subsystems of a service or application, and may also be employed in conjunction with hosted applications and services that may be implemented via software executed over one or more servers 406 or individual server 414. A hosted service or application may communicate with client applications on individual computing devices such as a handheld computer, a desktop computer 401, a laptop computer 402, a smart phone 403, a tablet computer (or slate), (‘client devices’) through network(s) 410 and control a user interface presented to users.

Client devices 401-403 may be used to access the functionality provided by the hosted service or application. One or more of the servers 406 or server 414 may be used to provide a variety of services as discussed above. Relevant data may be stored in one or more data stores (e.g., data store 409), which may be managed by any one of the servers 406 or by database server 408.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 410 may also coordinate communication over other networks such as PSTN or cellular networks. Network(s) 410 provides communication between the nodes described herein. By way of example, and not limitation, network(s) 410 may include wireless media such as acoustic, RF, infrared and other wireless media.

Many other configurations of computing devices, applications, data sources, and data distribution systems may be employed to implement a logging schema to track usage data between subsystems of a service or application. Furthermore, the networked environments discussed in FIG. 4 are for illustration purposes only. Embodiments are not limited to the example applications, modules, or processes.

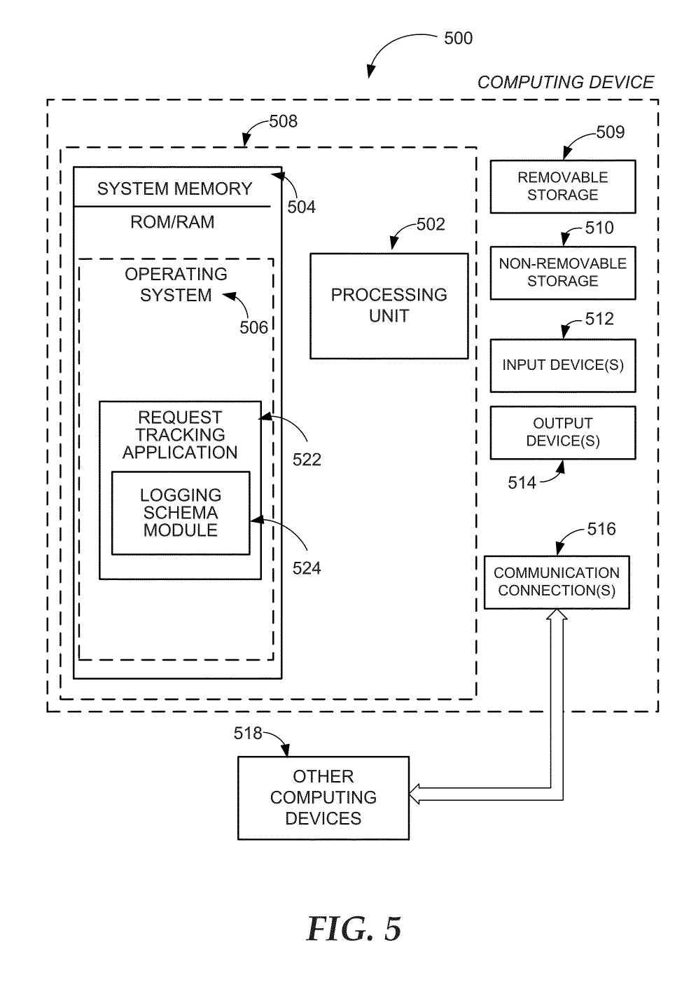

FIG. 5 and the associated discussion are intended to provide a brief, general description of a suitable computing environment in which embodiments may be implemented. With reference to FIG. 5, a block diagram of an example computing operating environment for an application according to embodiments is illustrated, such as computing device 500. In a basic configuration, computing device 500 may be any of the example devices discussed herein, and may include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 506 suitable for controlling the operation of the platform, such as the WINDOWS®, WINDOWS MOBILE®, or WINDOWS PHONE® operating systems from MICROSOFT CORPORATION of Redmond, Wash. The system memory 504 may also include one or more software applications such as a request tracking application 522 and logging schema module 524.

The logging schema module 524 may operate in conjunction with the operating system 506 or request tracking application 522 to monitor requests as they are received at a collaborative service and are processed by one or more subsystems of the collaborative service. The logging schema module 524, in conjunction with the request tracking application 522, may create and store a logging entry for each request as it is processed at a subsystem of the collaborative service to enable detailed monitoring of operations performed by the collaborative service. Each logging entry may include an identity of a subsystem processing the request, an operation executed by the subsystem to fulfill the request, a start and end time for the operation, localized user information for a received request, and error information associated with fulfillment of the request. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, an optical capture device for detecting gestures, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute communication applications, other directory or policy servers, and comparable devices. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods to provide a logging schema to track usage data between subsystems of a service. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

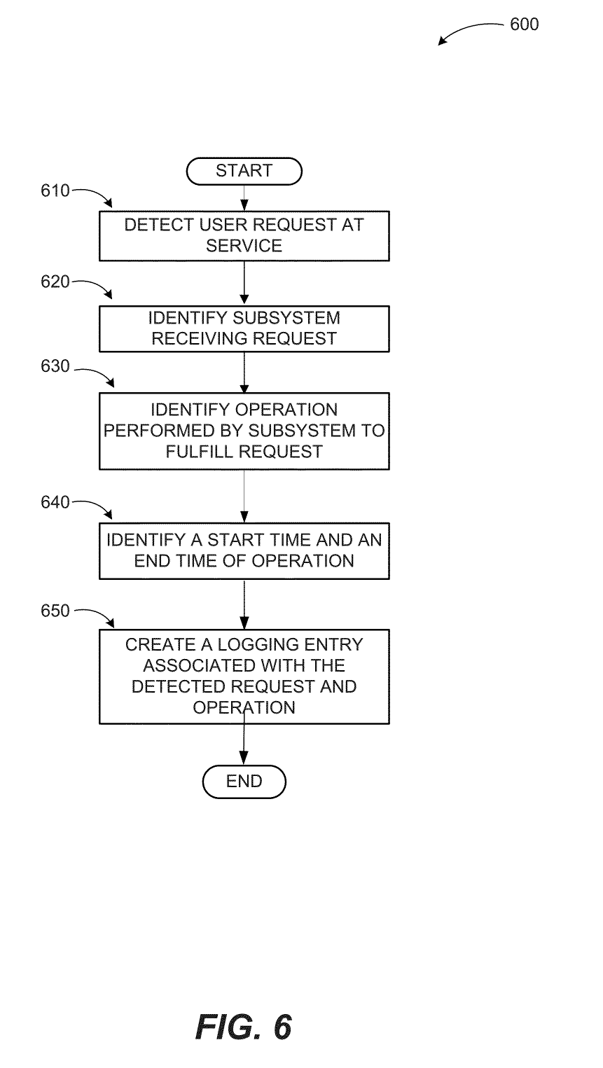

FIG. 6 illustrates a logic flow diagram for a process of providing a logging schema to track usage data between subsystems of a service, according to embodiments. Process 600 may be implemented as part of an application or an operating system.

Process 600 begins with operation 610, “DETECT REQUEST AT SERVICE” where a request to perform an operation is received at a collaborative service. A request may be any request received by the collaborative service by a user over a network to perform an operation associated with an application accessed at the user's client device.

Operation 610 is followed by operation 620, “IDENTIFY SUBSYSTEM RECEIVING REQUEST,” where a subsystem of the collaborative service receiving the request is identified. The collaborative service may include multiple subsystems configured to process requests, and the requests may travel between the multiple subsystems to fulfill the request.

Operation 620 is followed by operation 630, “IDENTIFY OPERATION PERFORMED BY SUBSYSTEM TO FULFILL REQUEST,” where an operation performed by the subsystem to fulfill the request is identified.

Operation 630 is followed by operation 640, “IDENTIFY A START TIME AND AN END TIME OF OPERATION,” where a start and end time for the operation performed to fulfill the request is determined. The start time and end time together may indicate a processing time of each subsystem, which may provide information about an overall performance and reliability of the collaborative service.

Operation 640 is followed by operation 650, “CREATE A LOGGING ENTRY ASSOCIATED WITH THE DETECTED REQUEST AND OPERATION,” where a logging entry is created at a data store associated with the service. The logging entry may include the subsystem name, operation identity, and the start and end time for the request. The logging entry may also include error detection name, description, code, and optionally other notes relevant to the operation.

The operations included in process 600 are for illustration purposes. Providing logging schema to track requests between subsystems of a service according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device to provide a logging schema to track requests between subsystems of a service, the method comprising:
detecting a request received by a service;
identifying a subsystem receiving the request;
identifying an operation performed by the subsystem to fulfill the request;
identifying a start time and an end time for the operation performed to fulfill the request; and
creating a logging entry at a data store associated with the service, the logging entry including the subsystem, the operation, and the start time and the end time for the operation performed to fulfill request.

2. The method of claim 1, further comprising:
detecting an error in processing the received request at the subsystem.

3. The method of claim 2, further comprising:
recording an error description for the detected error with the logging entry at the data store.

4. The method of claim 3, further comprising:
including an internal error code and an error type with the recorded error description.

5. The method of claim 4, wherein the internal error code includes a local code identifier recognized by the service.

6. The method of claim 4, wherein the error type includes a locale agnostic string categorizing a type of the detected error and an associated operation at the subsystem.

7. The method of claim 1, further comprising:
identifying user locale information for the request.

8. The method of claim 1, further comprising:
monitoring a performance of the service based on the logging schema.

9. The method of claim 8, wherein monitoring the performance comprises:
monitoring a reliability, a processing time, a user traffic, and an error rate of the service.

10. The method of claim 1, further comprising:
receiving the request at a front end subsystem of the service.

11. The method of claim 1, further comprising:
maintaining the data store at a back end of the service.

12. A computing device to provide a logging schema to track requests between subsystems of a service, the computing device comprising:
a memory;
a processor coupled to the memory, the processor executing a request tracking application, wherein the request tracking application is configured to:
detect a request received at by the service;
identify a subsystem receiving the request;
identify an operation performed by the subsystem to fulfill the request;
identify a start time and an end time for the operation performed to fulfill the request;
identify user locale information for the request; and
create a logging entry at a data store associated with the service, the logging entry including the subsystem, operation, the user locale information, and the start time and the end time for the operation performed to fulfill request.

13. The computing device of claim 12, wherein the service is a collaboration service facilitating one or more of: a communication exchange, a document sharing, an enterprise management, a document management, a file management, a collaboration, a social networking contacts management, a calendar management, a data sharing, and an application sharing.

14. The computing device of claim 12, wherein the request is one or more of: initiating an application, opening a document, initiating a conversation, interacting with a document or application, and retrieving data associated with an application.

15. The computing device of claim 12, wherein the request tracking application is further configured to:
detect an error in processing the received request at the subsystem.

16. The computing device of claim 15, wherein the request tracking application is configured to:
record an error description for the detected error with the logging entry at the data store, wherein the error description includes an internal error code and an error type.

17. The computing device of claim 15, wherein the request tracking application is configured to:
distinguish between a real user request and a bot request.

18. A computer-readable memory device with instructions stored thereon to provide a logging schema to track requests between subsystems of a service, the instructions comprising:
detecting a request received at by the service;
identifying a subsystem receiving the request;
identifying an operation performed by the subsystem to fulfill the request;
identifying a start time and an end time for the operation performed to fulfill the request;
identifying user locale information for the request; and
creating a logging entry at a data store associated with the service, the logging entry including the subsystem, the operation, the start time and the end time for the operation performed to fulfill request, and the user locale information for the request.

19. The computer-readable memory device of claim 18, wherein the instructions further comprise:
detecting an error in processing the received request at the subsystem;
recording an error description for the detected error with the logging entry at the data store, wherein the error description includes an internal error code and an error type; and
providing a localized error message to a requesting user.

20. The computer-readable memory device of claim 19, wherein the instructions include:
enabling an administrator of the service to customize the logging schema to define one or more subsystems to monitor, a monitoring frequency, and a type of data to be monitored.
